(19) United States
(12) Patent Application Publication
(10) Pub. No.: US 2002/0135593 A1
(43) Pub. Date: Sep. 26, 2002

(54) Color system in which color materials are mixed and created based on a geometric progression, color system to express colors by computers, and colored cubic model color file

(76) Inventor: Takeo Kawamura, Niiza-City (JP)

Correspondence Address: Takeo KAWAMURA, 1-20-9, HIGASHI, NIIZA-CITY, SAITAMA-PREF., 352-0002, JP

(21) Appl. No.: 09/814,307

(22) Filed: Mar. 21, 2001

(51) Int. Cl. G09G 5/02

(52) U.S. Cl. 345/589

(57) ABSTRACT

To make to possible for any one to create a color system by mixing materials based on a geometric progression as well as to arrange colors quickly by computer-based expression method. To provide a systematic color arrangement and production method according to a geometric progression and matrix ( computer-based numeric value table). As the color material is mixed, you may indicate the unit of mixture as 1. That is, it is expressed by numeric values by making length 1×width 1×height 1. The feature is that you can create a color system by mixing it in a method of geometric progression ratio=½ and that you can express the colors in computer display by putting systematic determinant values.

### TITLE OF THE INVENTION

Color system in which color materials are mixed and created based on a geometric progression, Color system to express colors by computers, and Colored cubic model color file.

### BACK GROUND OF THE INVENTION

The mix color system in this invention is concerned with the color system in which you mix color materials to express by numeric values, create a color system form the values based on a geometric progression and express the colors on the screen by inputting such numeric values in a computer.

There are tens of kinds of color systems currently. They are roughly divided into a theoretical system and a physical system. The invented system is made by the combination of those two types.

The current systems have the following defects.

a. Each color system uses color materials, but has no concrete production method.

b. There are no systematic numeric values to be input in computers.

As this invention solves the above problems and enable to express colors systematically in the computer display using color materials and numeric values, it will be very useful for design works in color arrangement.

### SUMMARY OF THE INVENTION

If you make any mixed color material cubic, it becomes the cubic coefficient and you can make it a numeric value to create the color system in which color materials are converted to numbers. The production method is to measure color samples in the color system with a spectroscope and systemize the colors according to JISZ8721 of color expression system. Since it is impossible to input JISZ8721 in a computer, I invented a method to display a color system on the computer screen by matching it with the numeric values of JISZ8729L*a*b*.

### DETAILED DESCRIPTION OF THE INVENTION

Hereafter, the implementing form of this invention is explained. Measure two kinds of color materials, black and white, and put the same quantity of each material into a mixing container. A gray material is created which is called “the 1^{st} mix color.” Divide the 1^{st} mix color material into a half.

If you add the same quantity of white material to the half 1^{st} mixed material and mix them, the 2^{nd}+mixed color is generated.

Divide it into a half and add a white material to it, the color sample of brightness degrees is created. For less bright color, divide a gray material into a half, and add a black material to it to make the 2^{nd}−mixed color. Next, mix a chromatic color material with a gray material of the same brightness. By repeating the same mixing way as the brightness degree creation, a color sample of chromatic degrees is created. Measure the color sample created in this way, with a spectroscope, and you obtain a numeric value of L*a*b*. Inputting the value in a computer, you can express colors by a computer program.

If you use this invented system for arranging colors in the design of architectural, commercial and industrial fields, you are able to create any color you like and to arrange various colors easily. Also, with a computer, you can arrange any colors quickly and store the color sample materials in the computer. In an educational institute of art, you can teach how to mix colors more concretely and systematically, comparing with the current method based on a sense.

### BRIEF DESCRIPTION OF FIGURES

FIG. 1

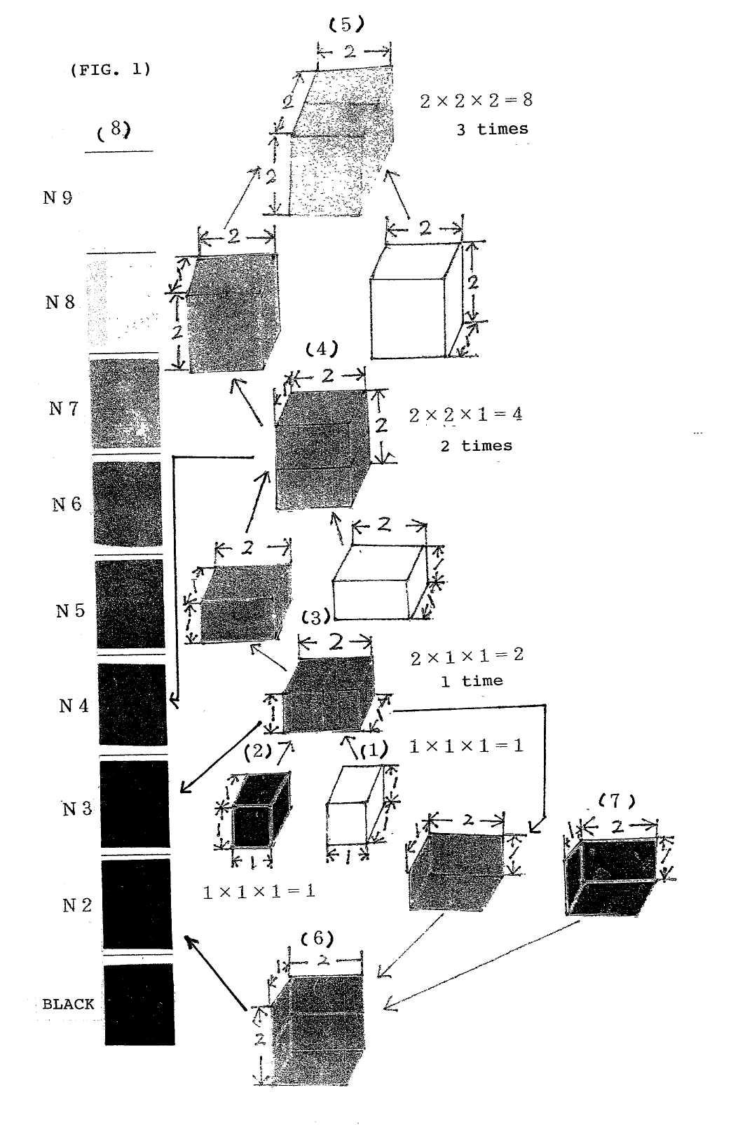

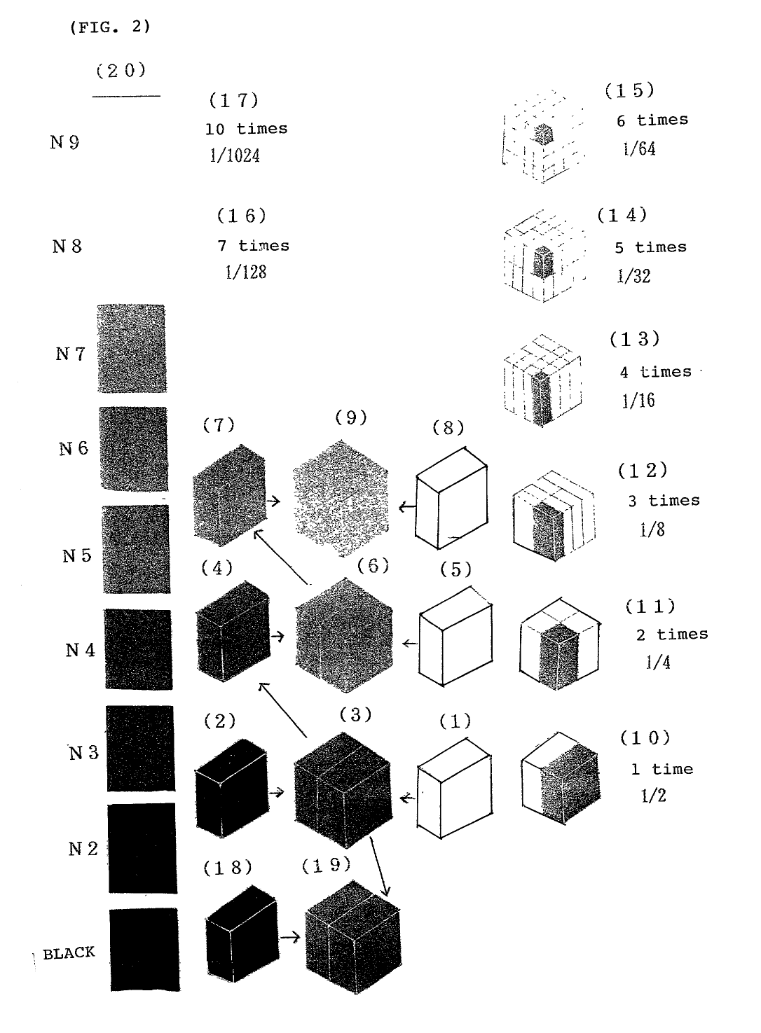

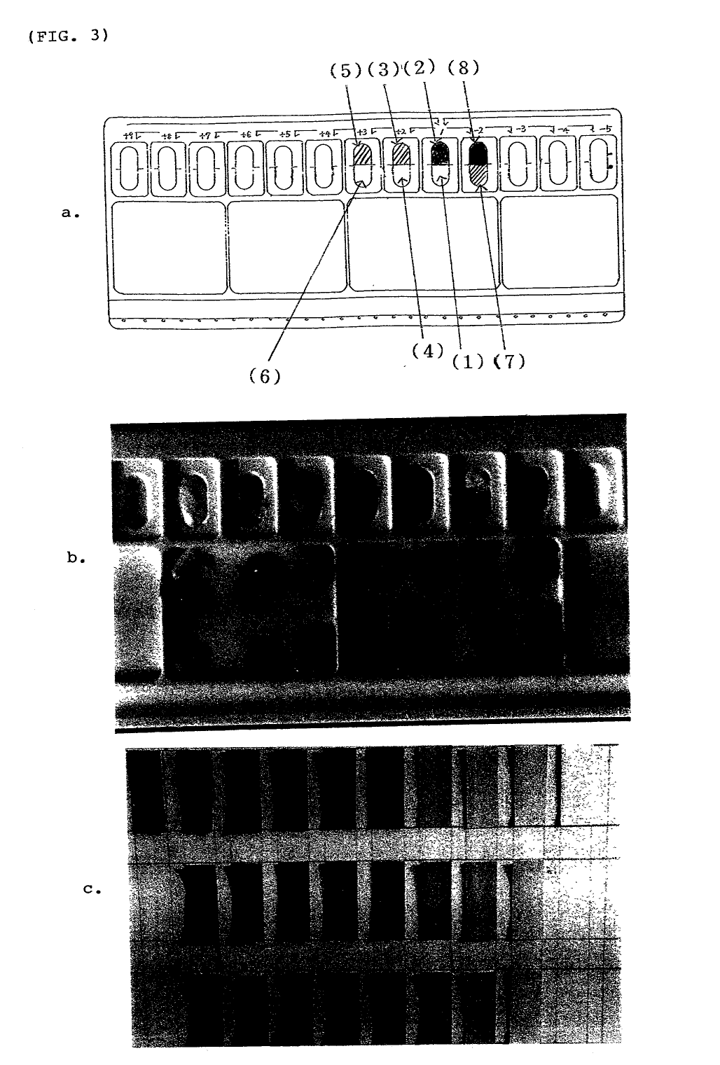

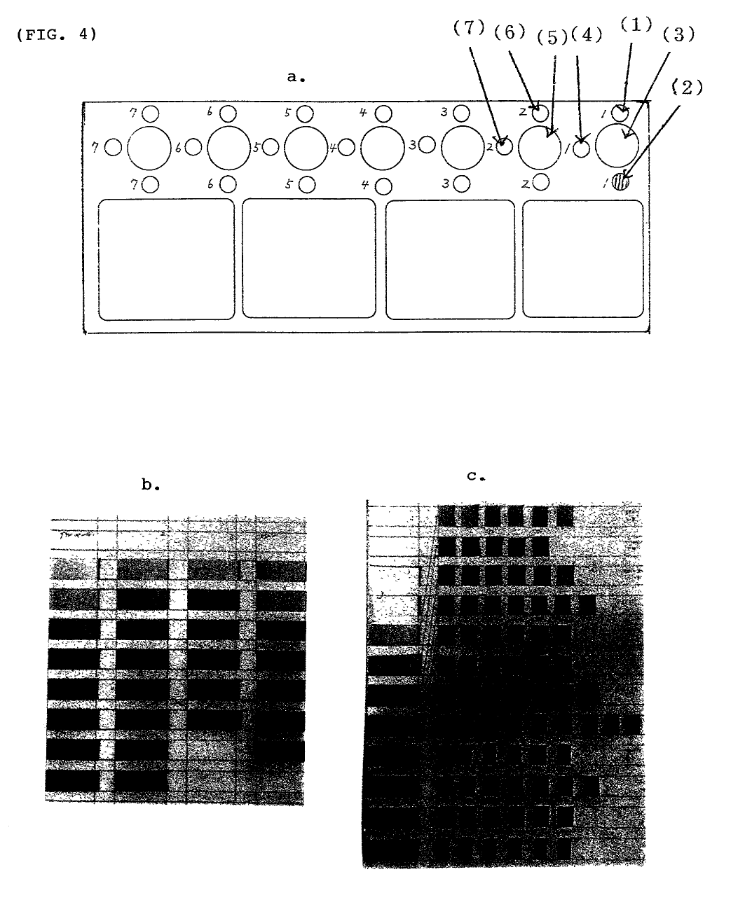

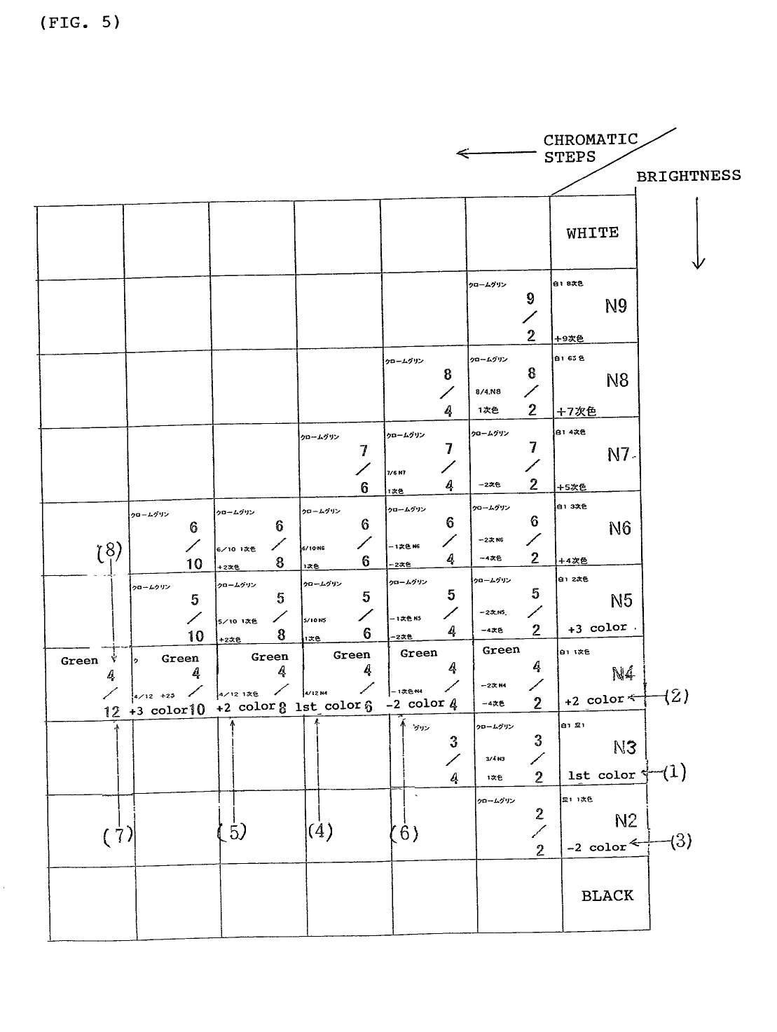

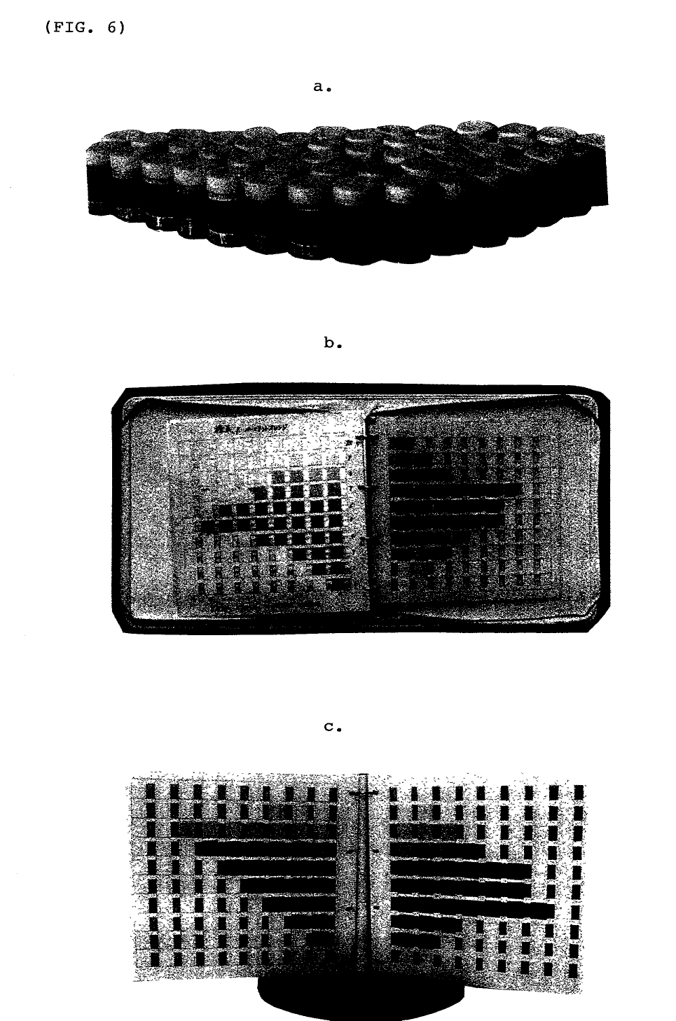

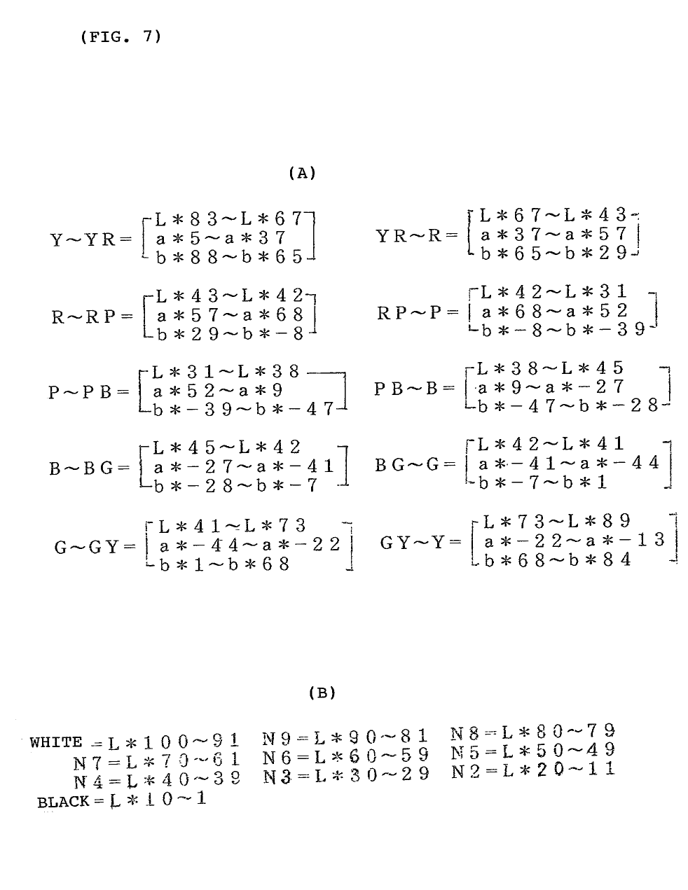

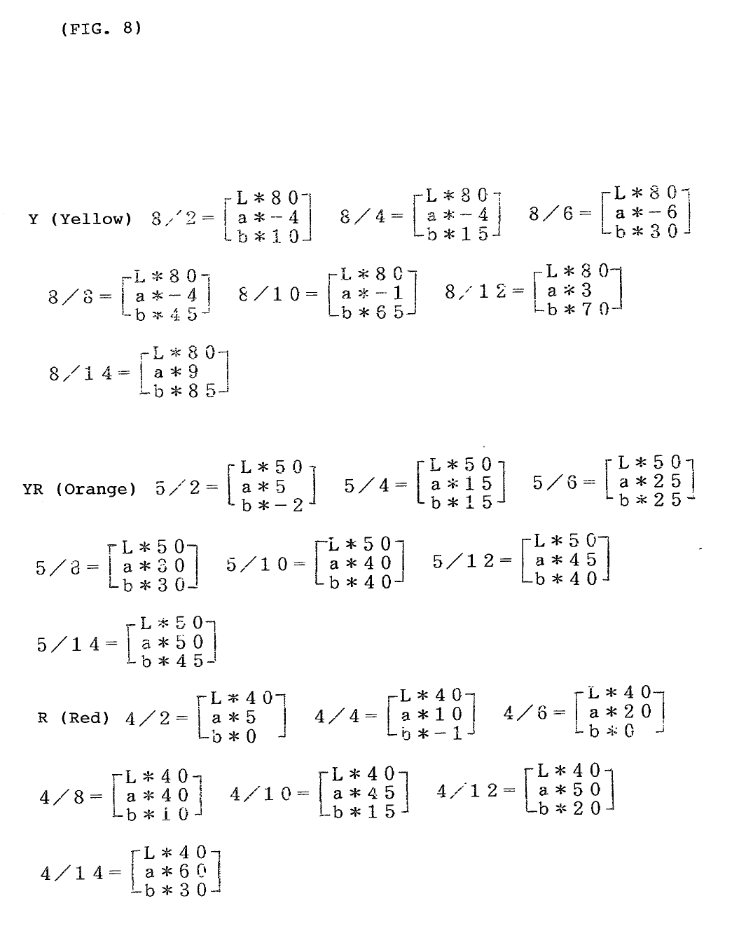

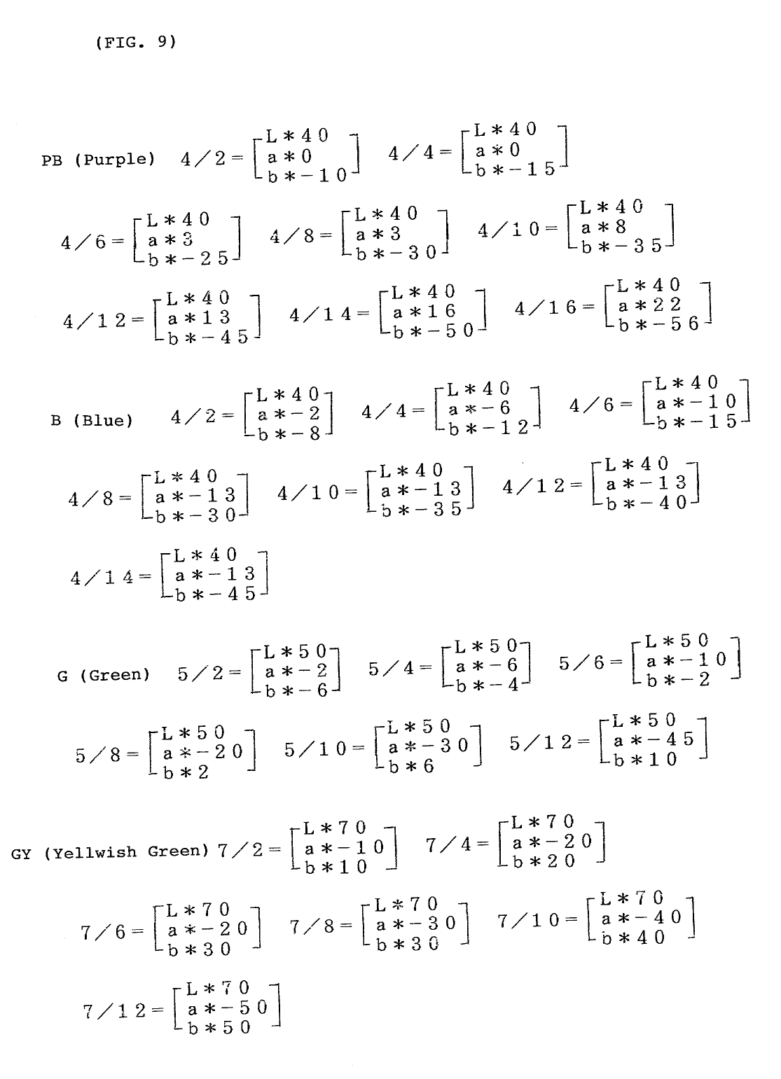

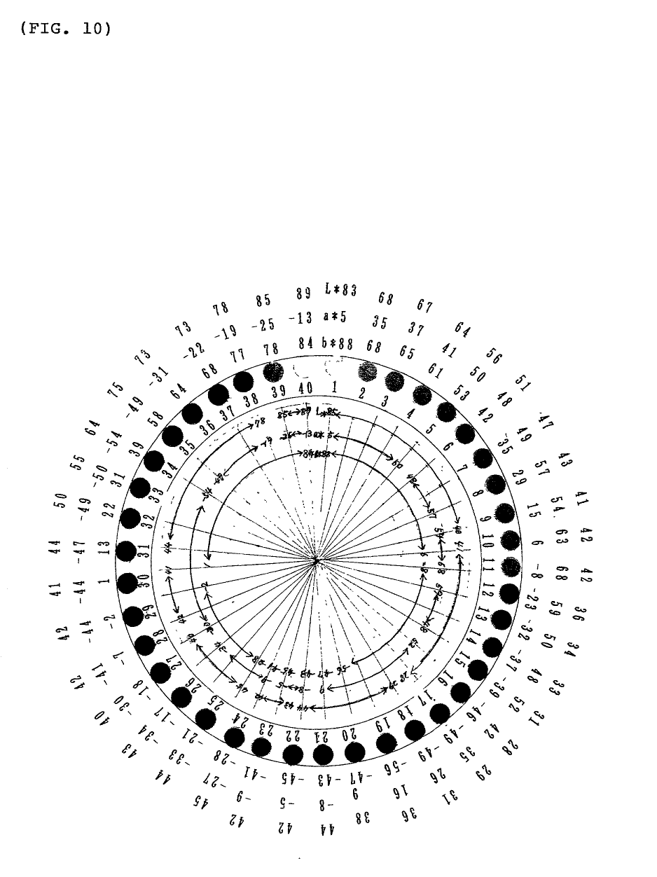

The principle of mixed colors is shown. The mixed color is made by mixing a color material with another material, which is expressed by numeric values on condition that length 1×width 1×height 1. The mixture is shown by the geometric progression in equal ratio 2. The colors are expressed in accordance with the standard of color expression, JISZ8721.

Description of Symbols

(1) White color material: 1×1×1=1

(2) Black color material: 1×1×1=1

(3) Mixture of white material with black material: 2×1×1=2

The first mixture makes a color of which achromatic color brightness is #3.

(4) A material made by adding the same quantity of white material to the material of above (3). 2×2×1=4 Against the color material volume of black, the volume of white material becomes four times as much as that. The second mixture makes a color of which achromatic color brightness is #4.

(5) Add the same quantity of white material to the material of above (4). 2×2×2=8 The volume of white material becomes eight times bigger.

The third mixture makes a color of which achromatic color brightness is #5. For the colors of brightness #6 or higher, repeat the same process.

(6) Add the same quantity of black material to the mixture (3). The color of brightness #2 is expressed.

(7) The expression of black material.

(8) Color sample according to the color expression way of JISZ8721.

FIG. 2

The figure shows that you can mix any mixed material at a certain quantity if you repeat the dividing mixture, when you mix color materials, on condition that the geometric progression ratio is ½. The colors are expressed in accordance with the color expression criteria of JISZ8721.

Description of Symbols

(1) 1 shall represent the numeric value of White Material.

(2) 1 shall represent the numeric value of Black Material.

(3) By mixing the White and Black Materials, Gray Material of which achromatic brightness is N3. Make its numeric value 2.

(4) Divide the Gray Material of the above (3) to a half, move one half and make it (4).

(5) White Material of the same quantity as that of the Gray with N3 achromatic brightness in above (4).

(6) By mixing the materials of (4) with (5), an achromatic color of which achromatic brightness is N4. The numeral value of Black becomes one-fourth of that of White.

(7) Divide the Gary of (6) into a half and move it.

(8) Add the same quantity of White (8) to the Gray of (7).

(9) By mixing the materials of (7) and (8), an achromatic Gray of which brightness is N5.

(10) The first mixing times of White and Black materials. The mixing ratio of two materials is 1:2. It is possible to express the achromatic color of brightness N3.

(11) The second mixing times, and the numeric ratio of White 3/4, Black 1/4. It is possible to express the achromatic color of brightness N4.

(12) The third mixing times, and the numeric ratio of White 7/8, Black 1/8. It is possible to express the achromatic color of brightness N5.

(13) The fourth mixing times, and the numeric ratio of White 15/16, Black 1/16. It is possible to express the achromatic color of brightness N6.

(14) The fifth mixing times, and the numeric ratio of White 31/32, Black 1/32. It is possible to express the achromatic color of brightness N7.

(15) The sixth mixing times, and the numeric ratio of White 63/64, Black 1/64.

(16) The seventh mixing times, and the numeric ratio of White 127/128, Black 1/128. It is possible to express the achromatic color of brightness N8.

(17) The tenth mixing times, and the numeric ratio of White 1023/1024, Black 1/1024. It is possible to express the achromatic color of brightness N9.

(18) Black Material.

(19) Mix the same quantity of (18) Black with the (3) achromatic Material of brightness N3. It is possible to express the achromatic color of brightness N2.

(20) Color sample according to the color expression way, JISZ8721.

FIG. 3

The mixing container for generating color materials.

Description of Symbols

a Mixing container for generating color materials.

b Photo showing the mixture state when the materials are actually put in the container.

c Photo showing the systematic brightness degrees of the colors generated by the container.

(1) Put White Material into the hollow of the container until it reaches the mark line.

(2) Put Black Material into the same hollow until it reaches a middle of the mark line and mix them. Then, Gray Material of brightness N3 is created.

(3) Move a half of N3 Gray to +2 hollow. (4) Put White Material into +2 hollow until it reaches the line. Then, Gray Material of brightness N4 is created.

(5) Move N4 Gray to +3 hollow until it reaches the line.

(6) Put White Material into +3 hollow and mix them. Then, Gray Material of brightness N5 is created.

(7) Move N3 Gray to −2 hollow.

(8) Put Black Material into −2 hollow. Then, Gray Material of brightness N2 is created.

FIG. 4

a Mixing container for generating color materials

b Color sample of brightness steps generated by liquid color materials mixing container.

c Color sample of chromatic steps generated by liquid color materials mixing container.

(1). Put White Material into a hollow of liquid color materials mixing container.

(2). Put Black Material into another hollow of liquid color materials mixing container

(3). Move both White Material in a hollow (1) and Black Material of (2) to the hollow (3), and mix them.

(4). Move Gray Material mixed in Hollow (3) to Hollow (4) to keep it in a certain quantity.

(5). Move Material from Hollow (4) to Hollow (5).

(6). Put White Material into Hollow (6). Move it to Hollow (5) and mix them.

(7) Move Material from Hollow (5) to Hollow (7). By such repetition, the color materials of various brightness steps and chromatic steps are generated.

FIG. 5

In this invention, the mixture times are shown, using green group materials, in accordance with the values provided in JISZ-8721.

Description of Symbols

(1) The 1^{st} color shows the first mixture.

(2) Following +2 color means that White was added in the 2^{nd} mixing.

(3) Next −2 color means that Black was added in the 2^{nd} mixing.

(4) Represents the 1^{st} time when N4 achromatic color material and N4 chromatic material for generating the chromatic steps.

(5) +2 color means that 4/12 color material was added to the #4 mixture above.

(6) −2 color means that N4 was added to −2 color.

(7) /12 is a value to mean the chromatic steps.

(8) 4/ is a value to mean the brightness steps.

FIG. 6

a Color Material created by matching a material with JISZ8721.

b Color File made by pasting the color sample with Material a .

c Cubic Color Model by composing Color File b three-dimensionally.

FIG. 7

Numeric values to express a hue of color system on the computer screen, as the coordinates of color expression, JISZ8729, Y, YR, R, RP, P, PB, B, BG, G, GY of L * a * b *.

A. Numeric value to express the hue steps of L * a * b *.

B. Numeric value to express the brightness steps of L * a * b *

FIG. 8

Numeric values to represent the chromatic steps on the computer screen of FIG. 7.

FIG. 9

Consecutive process to express the chromatic steps of FIG. 8.

FIG. 10

Color sample made by printing out from the computer and displayed numeric values on the screen by generating 40 color materials, based on the color expression way L * a * b * system.

What is claimed is:

1. First, select any two optional materials from color materials. For example, select white and black, white and blue or red and yellow. Then, mix those two color materials of the same quantity respectively and divide a new mixed color material optionally. Add one kind of material in the equivalent quantity to such divided and reduced material. By repeating this process, a color expression way by three attributes can be build up, including the brightness degree and chromatic degree which meet JISZ8721. As the color material is mixed, the unit of mixture quantity is represented as #1. That is, it becomes possible to express by the numeric values of cubic coefficients on condition that depth 1×width 1×height 1, and to systemize a mix method with geometric progression common ratio numeric values. For instance, in the production of brightness steps, mix the same quantity of two kinds of color materials, which is called “the first mixed color.” Divide the first mixed color into a half, and either half one is then mixed with another material of the equivalent quantity. This one is called “the second mixed color.” By repeating these processes, you make the 3^{rd} mixed color, 4^{th} mixed color and so on. For such mixed colors generated in this way, indicate a direction of higher degree brightness as plus (+), and a direction of lower degree brightness as minus (−). To produce the chromatic steps, you use a system which has been built in the brightness production. That is, among the color materials, gray material, made by mixing black and white, is considered to be the criteria. In the mixed gray materials, select a gray of any optional brightness, and mix it with the same quantity of some colors, with the same brightness and the highest chromatic ratio, such as green, yellow and magenta, etc. The color is called the 1^{st} mixed color. Divide the color into a half, to which you add the high brightness material used initially or the gray one added initially for mixing. Repeating this process, the 2^{nd} mix color, 3^{rd} mix color and etc. are generated, and it becomes possible to express them by numbers. In mixing, indicate any mix color by adding high brightness ones as (+), and any mix ones by adding gray as (−). It is the colored cubic model color file mentioned in the beginning and the mix color production method featuring that you can understand in what mixing way the color you select at random has been produced, by expressing the mixing times with numeric values.

2. You make multiple hollows on the flat surface of mixing container for mixing, which is used for generating the mix color described in Application Item 1. It is easy to measure the color material and the mixing work will finish in a short time, by putting ½ or ⅓ scale in the half depth of hollows. Divide the mix material into a half, and move it to another hollow to add another material and mix them. By repeating this process, you can make the 2st mixed color, 3^{rd} mixed color and so on easily. If you put previously the number of mixing times in the position of each hollow, where seen easily, in the mixing container, you can check the mixing times without troubles. The mixing container for generating color material featuring that it is also useful for gas and liquid materials by changing the depth or position of the hollows in the container.

3. The Hue of color system in which the mixed colors described in the Application Item 1 are displayed on a computer screen. For example, the numeric value table to express the hue of color system on (A) of FIG. 7, as the coordinates based on J I S Z 8 7 2 9, Y, Y R, R, R P, P, P B, B, B G, G, G Y of L * a * b *. A matrix of values to express the brightness and chromatic steps. A numeric value table of color system on computer, featuring that the colors are displayed as a 3D color system using numeric values.
